(19) United States
(12) Patent Application Publication
(10) Pub. No.: US 2017/0181071 A1
(43) Pub. Date: Jun. 22, 2017

(54) COMMUNICATION TERMINAL AND METHOD FOR SELECTING A COMMUNICATION ANTENNA

(71) Applicant: INTEL IP CORPORATION, Santa Clara, CA (US)

(72) Inventor: Dietmar LIPKA, Berg (DE)

(21) Appl. No.: 15/357,824

(22) Filed: Nov. 21, 2016

(30) Foreign Application Priority Data
Dec. 22, 2015 (DE) 10 2015 122 543.3

(51) Int. Cl. H04W 48/18; H04W 8/18; H04W 72/04; H04W 48/02

(52) U.S. Cl. CPC H04W 48/18; H04W 48/02; H04W 8/183; H04W 72/042

(57) ABSTRACT

According to one example, a communication terminal is described comprising a plurality of antennas, a plurality of subscriber identity modules and a transceiver for each subscriber identity module, wherein the subscriber identity module is configured to provide communication with a respective communication network of a plurality of communication networks by means of the transceiver via one or more of the antennas. The communication terminal further comprises a determiner for each subscriber identity module configured to determine, for at least one of the one or more of the antennas, a reception quality of a signal received by the transceiver for the subscriber identity module via the antenna and an antenna selector configured to receive indications of the reception qualities and to select an antenna of the plurality of antennas as communication antenna. Each subscriber identity module is configured to use the antenna selected as communication antenna for communication with the respective communication network.

### RELATED APPLICATION

This application claims priority to German Patent Application No. 10 2015 122 543.3, filed Dec. 22 2015, the contents of which are hereby incorporated by reference herein.

### TECHNICAL FIELD

Embodiments described herein generally relate to communication terminals and methods for selecting a communication antenna.

### BACKGROUND

Modern communication devices may include a plurality of antennas to support advanced communication technologies. For example, data may be received simultaneously via a plurality of antennas to achieve higher robustness and throughput. However, for transmission (i.e. sending), a lot of devices only use a single antenna such that one of the antennas needs to be selected as transmission antenna. This is typically done based on evaluation of the performance of the antennas and a selection of the antenna with the highest performance as transmission antenna. If, however, a plurality of entities, e.g. modem instances associated with different subscriber identity modules, perform reception quality measurements on the available antennas, an efficient scheme is needed to evaluate the measurement results, select a transmission antenna and control the respective transceivers to use the selected transmission antenna.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows a communication system, e.g. an LTE (Long Term Evolution) communication system.

FIG. 2 shows a radio cell arrangement including two communication networks.

FIG. 3 shows components of a communication terminal related to antenna selection.

FIG. 4 shows components of a communication terminal related to antenna selection.

FIG. 5 shows a communication terminal.

FIG. 6 shows a flow diagram illustrating a method for selecting a communication antenna.

### DESCRIPTION OF EMBODIMENTS

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

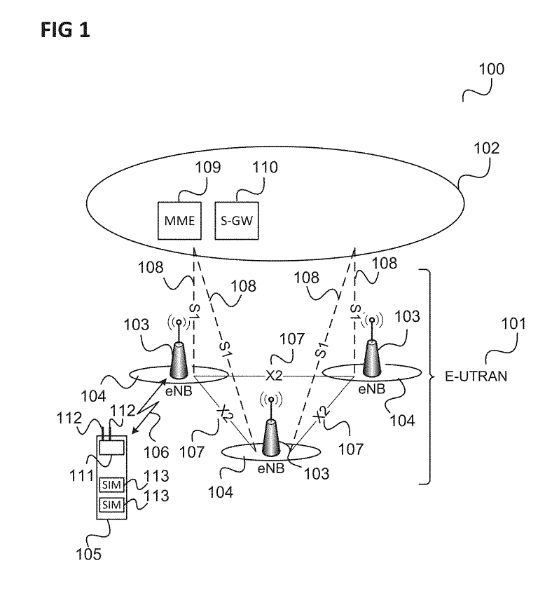

FIG. 1 shows a communication system 100, e.g. an LTE (Long Term Evolution) communication system.

The communication system 100 includes a radio access network (e.g. an E-UTRAN, Evolved UMTS (Universal Mobile Communications System) Terrestrial Radio Access Network according to LTE) 101 and a core network (e.g. an EPC, Evolved Packet Core, according LTE) 102. The radio access network 101 may include base (transceiver) stations (e.g. eNodeBs, eNBs, according to LTE) 103. Each base station 103 provides radio coverage for one or more mobile radio cells 104 of the radio access network 101.

A mobile terminal (also referred to as UE, user equipment, or MS, mobile station) 105 located in a mobile radio cell 104 may communicate with the core network 102 and with other mobile terminals 105 via the base station providing coverage in (in other words operating) the mobile radio cell.

Control and user data are transmitted between a base station 103 and a mobile terminal 105 located in the mobile radio cell 104 operated by the base station 103 over the air interface 106 on the basis of a multiple access method.

The base stations 103 are interconnected with each other by means of a first interface 107, e.g. an X2 interface. The base stations 103 are also connected by means of a second interface 108, e.g. an S1 interface, to the core network, e.g. to an MME (Mobility Management Entity) 109, and a Serving Gateway (S-GW) 110. For example, the MME 109 is responsible for controlling the mobility of mobile terminals located in the coverage area of E-UTRAN, while the S-GW 110 is responsible for handling the transmission of user data between mobile terminals 105 and core network 102.

The radio access network 101 and the core network may support communication according to various communication technologies, e.g. mobile communication standards. For example, each base station 103 may provide a radio communication connection via the air interface between itself and the mobile terminal 105 according to LTE, UMTS, GSM (Global System for Mobile Communications), EDGE (Enhanced Data Rates for GSM Evolution) radio access. Accordingly, the radio access network 102 may operate as an E-UTRAN, a UTRAN, a GSM radio access network, or a GERAN (GSM EDGE Radio Access Network). Analogously, the core network 102 may include the functionality of an EPC, a UMTS core network or a GSM core network.

For radio communication via the air interface 106, the mobile terminal 105 includes a radio transceiver 111 and, in this example, multiple antennas 112 and multiple subscriber identity modules 113. The radio transceiver 111 may include separate receive chains and transmit chains as well as separate baseband processors for the subscriber identity modules 113. It may for example include a common frontend which switches received signals and signals to be transmitted to the receive chains and the antennas, respectively.

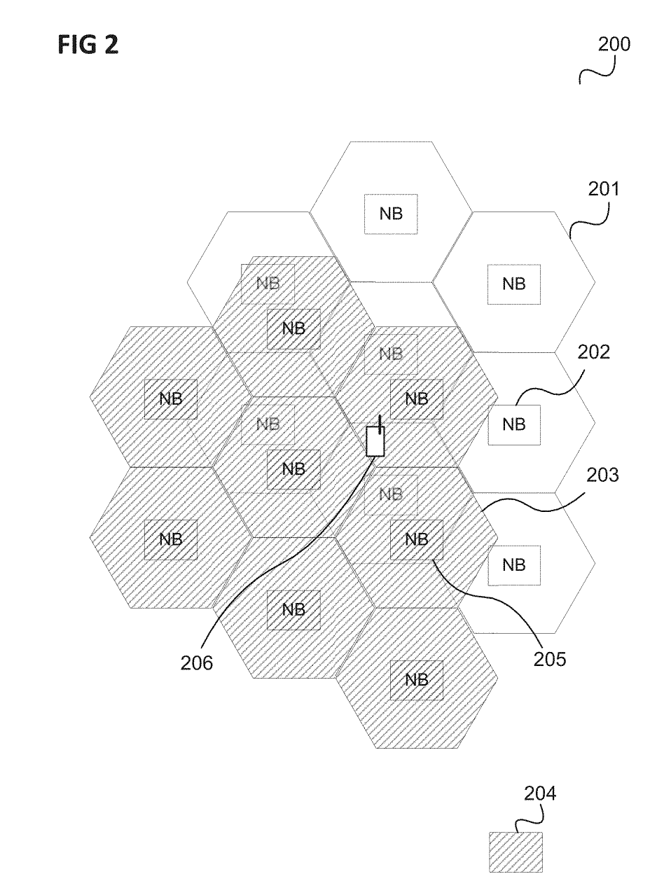

The mobile terminal 105 may be within the coverage area of more than one mobile communication network which may operate according to the same RAT (radio access technology) or according to different RATs. This is illustrated in FIG. 2.

FIG. 2 shows a radio cell arrangement 200 including two communication networks.

The radio cell arrangement 200 includes a first plurality of radio cells 201 (shown without hatching) operated by a plurality of first base stations 202 of a first communication network (e.g. LTE base stations eNB), e.g. operated by a first operator, and a second plurality of radio cells 203 indicated by a hatching 204 operated by a plurality of second base stations 205 of a second communication network, e.g. operated by a second operator (e.g. of a different RAT, e.g. UMTS base stations NB).

As illustrated, the second plurality of radio cells 203 overlaps the first plurality of radio cells 201 such that a mobile terminal 206, e.g. corresponding to mobile terminal 105, located in the overlapping area may connect to both the first communication network and the second communication network, e.g. may both register with a base station 202 of the first communication network and a base station 205 of the second communication network.

The mobile terminal 206, as described with reference to FIG. 1, may include multiple SIMs 113 which allow the mobile terminal 206 to connect to multiple communication networks (of possibly different operators) using a single terminal device or may support dual connectivity to connect to different base stations for an enhanced data rate. Further, according to modern radio access technologies (RAT) such as LTE, the mobile terminal 206 may, as described with reference to FIG. 1, include multiple antennas 112 to support diversity or even MIMO (multiple input multiple output) in downlink (i e for reception). However, the majority of mobile terminals being currently used still use only one antenna for transmission (i.e. uplink). A simple way to select one of multiple antennas 113 for transmission is to hard select one antenna for transmission. However, the so called body loss effect might degrade the gain of that antenna considerably while any of the other antennas is unaffected. To optimize in such case, rerouting capabilities for the transmitter (TX) to a better antenna may be provided.

For this, for example, a scheme called best antenna selection (BAS) may be used. According to BAS a communication terminal permanently measures the receive quality on all antennas and selects the best of them for transmission.

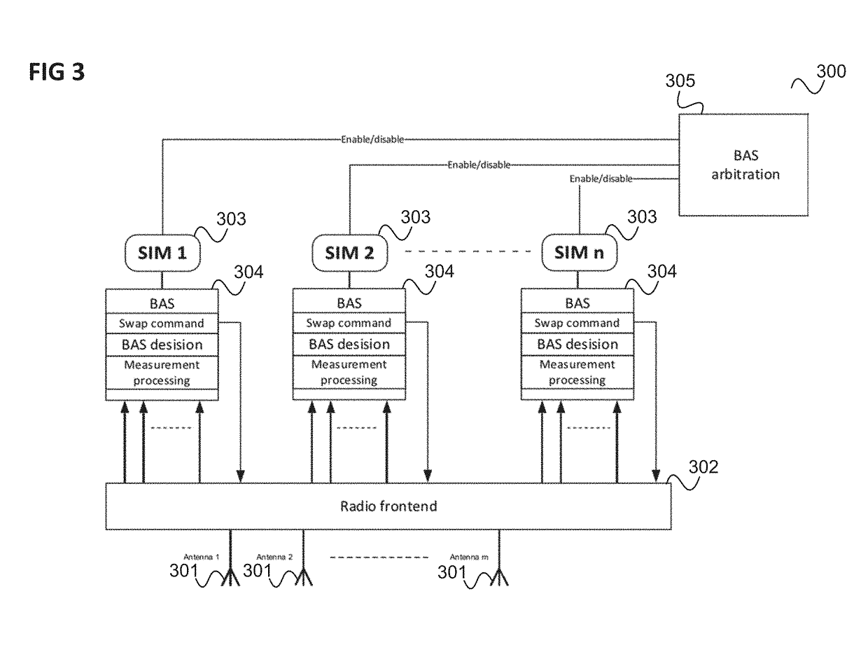

However, one characteristic of the body loss effect is that the best antenna does not depend on the band, used RAT or in case of multiple SIMs which of the SIM is using the transmitter. Further, due to cost reasons, radio front end and antenna hardware may be shared components in a communication terminal and may not allow each SIM to select the best antenna independently from each other. Consequently, if all SIMs would use BAS and try to get the best antenna it would cause conflicting settings. To avoid this, for multiple SIMs, a complicated arbitration method may be applied to ensure that only one SIM is running BAS and sets up antennas. For this, however, implementation and test effort is extremely high. This approach is illustrated in FIG. 3.

FIG. 3 shows components of a communication terminal 300 related to antenna selection.

The communication terminal 300 for example corresponds to the mobile terminal 105 and includes a plurality of antennas 301 coupled to a radio frontend 302 (which is for example part of the transceiver 111).

The communication terminal 300 further includes a plurality of SIMs 303, wherein for each SIM 303, a BAS processing block 304 providing a BAS scheme is provided. The BAS processing blocks 304 are for example implemented on a processor of the communication terminal in a context (e.g. a modem instance) of the respective SIM 303. The communication terminal 300 further includes a BAS arbitration block 305 (for example implemented by a processor of the communication terminal).

By means of the respective BAS processing block 304, each SIM 303 runs its own BAS instance with both decision algorithm and antenna selection execution. Each SIM has an associated modem instance which performs performance measurements (i.e. reception quality measurements) for those of the antennas 301 it has access to. In case of conflicts between the SIMs 303 due to limitations of the radio frontend 302 a SIM 303 may not have access to all antennas but possibly only to a subset of the antennas 301. A typical example is two SIMs and two antennas, where the first SIM only can be connected to one antenna and the second SIM can only be connected to the other antenna. In that case BAS would not be possible at all because each SIM's modem can only perform a performance measurement for one antenna and thus cannot compare its reception quality with the other antenna.

Furthermore, since each SIM 303 has its own BAS instance 304, each SIM 303 may select an antenna 301. To prevent conflicting settings only one SIM is allowed to enable BAS, while the others have to disable it. This enablement and disablement of the BAS blocks 304 is done by the central arbitration BAS unit 305 that decides which SIM 303 may enable BAS. This means that both the decision algorithm, with measurement acquisition and evaluation, and antenna selection is tied together and cannot be assigned to separate SIMs 303.

In the following, an approach is described which can be seen to be based on the principle to divide the BAS into two subparts, namely the decision algorithm and the execution of the antenna setting. Further, the decision algorithm is implemented as central unit running independently from the SIMs' activities. Each SIM's modem delivers measurements of the antenna quality properly scaled into a central storage where all measurements are collected. The central unit implementing the BAS decision algorithm reads the measurements from all SIMs and performs the evaluation and determination of which antenna is the best. This may be seen to be based on the fact that, with regard to body loss effect, the best antenna is typically independent from the frequency band, radio access technology and subscriber identity module. A further central unit enables one of the SIMs to execute the antenna setting according to the result of the decision algorithm to set the antennas accordingly.

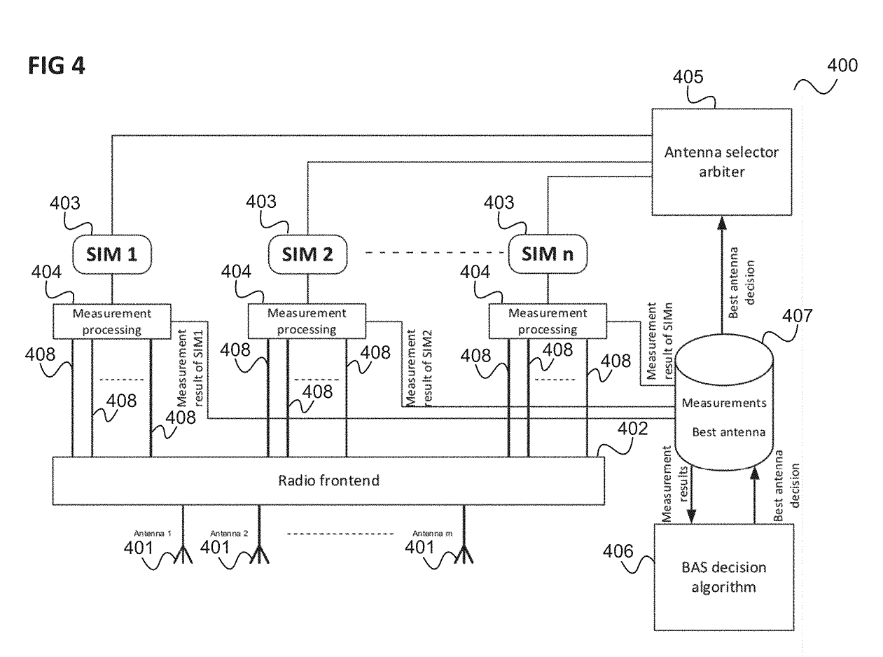

This approach is illustrated in FIG. 4.

FIG. 4 shows components of a communication terminal 400 related to antenna selection.

The communication terminal 400 for example corresponds to the mobile terminal 105 and includes a plurality of antennas 401 coupled to a radio frontend 402 (which is for example part of the transceiver 111).

The communication terminal 400 further includes a plurality of SIMs 403, wherein for each SIM 403, a measurement processing block 404 is provided. The measurement processing blocks 404 operate in baseband and are for example implemented on a processor of the communication terminal in a context (e.g. a modem instance) of the respective SIM 403. The communication terminal 400 further includes an antenna selector arbiter 405 (for example implemented by a processor of the communication terminal), a BAS decision block 406 implementing a BAS decision algorithm (for example implemented by a processor of the communication terminal) and a storage 407 (for example implemented by a memory of the communication terminal).

The BAS decision algorithm is thus implemented in form of a single instance 406 independent of the SIMs 403. The BAS decision (in form of the BAS decision block 406) and the antenna selection execution (in form of the antenna selector arbiter 405 and the SIM 403 which is enabled for antenna selection) are separated from each other such that the considerable higher flexibility of a distributed architecture is provided. In particular, the measurements are collected from all SIMs 403 in the storage 407 and are jointly evaluated by the BAS decision block 406. Since the different RATs which may be used by the SIMs 403 may use different metrics for antenna measurement values, the measurements are, e.g. by the measurement processing blocks 404, properly scaled before being forwarded to the storage 407 to allow a correct comparison. Alternatively, the BAS decision block may take this into account and for example perform a corresponding scaling.

Since all measurements are available to the BAS decision block 406, conflicts can be avoided. Further, because the decision algorithm is separated from the SIMs 403 it can be run any time without the need to arbitrate enabling or disabling. In other words, the corresponding arbitration is not needed anymore. Arbitration of the antenna setting between the SIMs 403 still remains but is much simpler compared to the approach of FIG. 3, since the BAS arbitration block 405 only needs to decide on the needs of one BAS decision algorithm instance, i.e. in a one-dimensional manner, and not the combined needs of two functions, namely BAS decision algorithm and antenna setting execution, i.e. in a two-dimensional manner

For example, each SIM 403 has an associated modem instance which performs measurements on the antennas it has access to and processes the measurements by means of its measurement processing block 404 (e.g. scales them according to the respective radio access technology). Each SIM 403 then provides the measurement results to the storage 407. The BAS decision block 406 analyzes the measurements and determines the best antenna, i e makes a decision about the best antenna based on the measurements, and stores the result, i.e. an indication of the best antenna, in the storage. The antenna selector arbiter 405 reads the indication of the best antenna from the storage, determines the SIM 403 which may select the best antenna, enables this SIM 403 for antenna selection and sends the indication of the best antenna to this SIM 403.

The SIM 403 thus enabled for selection selects the antenna as indicated by the indication of the best antenna as transmission antenna (or possibly, generally as communication antenna, i.e. for reception and transmission).

The measurements are for example measurements on reference signals or pilot signals of the received power or the reception field strength such as RSRP (Reference Signal Received Power) and RSCP (Received Signal Code Power). Accordingly, the measurement results generated by the measurement processing blocks 404, provided to the storage 407 and evaluated or analyzed by the BAS decision block 406 for the decision, which antenna is the best antenna (i.e. which antenna is expected to have the best transmission performance) may be measures of reception quality such as RSRP and RSCP, e.g. for a certain frequency range. The BAS decision block 406 may select the antenna which gives, e.g. averaged over a plurality of measurements possibly provided by a plurality of measurement processing blocks 405, the highest reception quality (e.g. the highest received power).

The measurement processing blocks 404 may for example determine the measurement results based on signal samples provided to them via receive chains 408 based on signals received by the frontend 402. For example, the frontend 402 may be coupled to each measurement processing block 404 (which is for example part of the baseband processor for the respective SIM) by a number of RX chains 408 corresponding to the number of receive antennas the respective SIM 404 supports. The communication terminal 400 may, however, for example, only include a single transmit (TX) chain (not shown) per SIM or even only a single transmit (TX) chain (not shown) that is shared by the SIMs 403 such that only a single transmit antenna may be used by the SIMs 403 for transmission. The receive chains and the (possibly shared) transmit chain of a SIM as well as the baseband processor for the SIM may be seen as part of a transceiver for the SIM.

The approach illustrated in FIG. 4 may be developed, implemented and tested with much less effort than conventional approaches as for example the approach of FIG. 3. Still, it may provide a better performance due to the involvement of all SIMs 403 to jointly measure the antenna qualities instead of only a single antenna. Further, measurement results may be obtained even when one of the SIMs performs procedures where no measurements can be done or where conflicts prevent measurements on all antennas while for example, in a typical case of two antennas and dual SIM (i.e. two SIMs), if one SIM (i.e. its associated modem) can only measure the first antenna and the other SIM (i.e. its associated modem) can only measure the second antenna, a decision (i.e. a transmit antenna selection) is not possible and BAS is inherently deactivated.

Further, for example, since in approach of FIG. 3 only one modem instance associated with a SIM can perform measurements it can happen that the measurement data are incomplete, since the modem instance may be in sleep for longer time or not all antennas can be accessed due to conflicts. According to the approach of FIG. 4, however, the measurments from all SIMs' modem instances complement each other, such that incomplete measurement data do not occur.

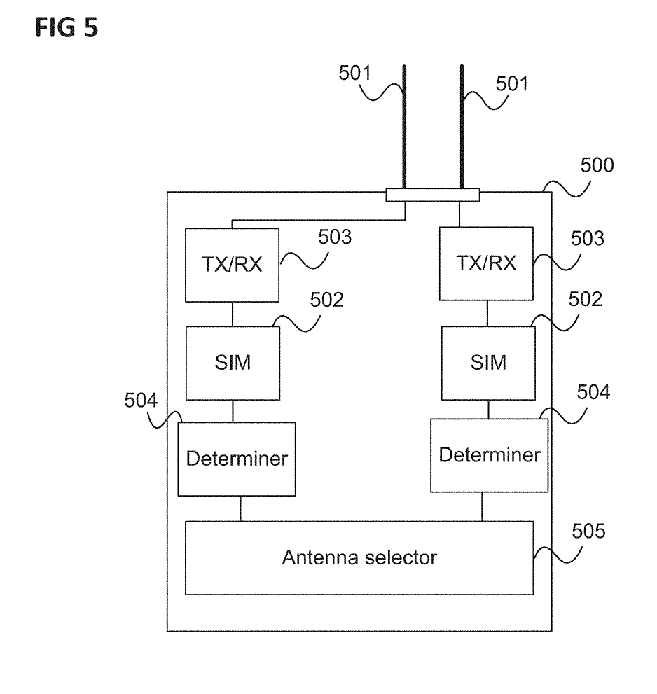

In summary, according to various examples, a communication terminal is provided as illustrated in FIG. 5.

FIG. 5 shows a communication terminal 500.

The communication terminal 500 includes a plurality of antennas 501 and a plurality of subscriber identity modules 502.

The communication terminal 500 further includes a transceiver 503 for each subscriber identity module 502, wherein the subscriber identity module 502 is configured to provide communication with a respective communication network of a plurality of communication networks by means of the transceiver 503 via one or more of the antennas 501.

Further, the communication terminal 500 includes a determiner 504 for each subscriber identity module 502 configured to determine, for at least one of the one or more of the antennas 501, a reception quality of a signal received by the transceiver 503 (which may for example include a plurality of receivers, e.g. one receiver for each antenna of the plurality of antennas 501) for the subscriber identity module 502 via the antenna 501.

The communication terminal 500 further includes an antenna selector 505 configured to receive indications of the reception qualities and to select an antenna 501 of the plurality of antennas 501 as communication antenna. Each subscriber identity module 502 is configured to use the antenna selected as communication antenna for communication with the respective communication network.

In other words, a central unit is provided in a communication terminal which gathers reception qualities determined by different subscriber identity modules and determines an antenna to be used as communication antenna (i.e. as transmission antenna for sending data from the communication terminal to, e.g. a base station, as reception antenna for receiving data from another communication device, e.g. a base station, or both) based on the reception qualities. The communication antenna may be the antenna to be used for transmission. However, it may also be the antenna (or an antenna) used for reception. For example, if a subscriber identity module can only use a subset of the antennas for reception, the subset may be set such that it includes the communication antenna, i.e. such that the communication antenna is set as reception antenna.

The components of the communication device (e.g. the transceivers, the determiner and the antenna selector) may for example be implemented by one or more circuits. A “circuit” may be understood as any kind of a logic implementing entity, which may be special purpose circuitry or a processor executing software stored in a memory, firmware, or any combination thereof. Thus a “circuit” may be a hard-wired logic circuit or a programmable logic circuit such as a programmable processor, e.g. a microprocessor. A “circuit” may also be a processor executing software, e.g. any kind of computer program. Any other kind of implementation of the respective functions which will be described in more detail below may also be understood as a “circuit”.

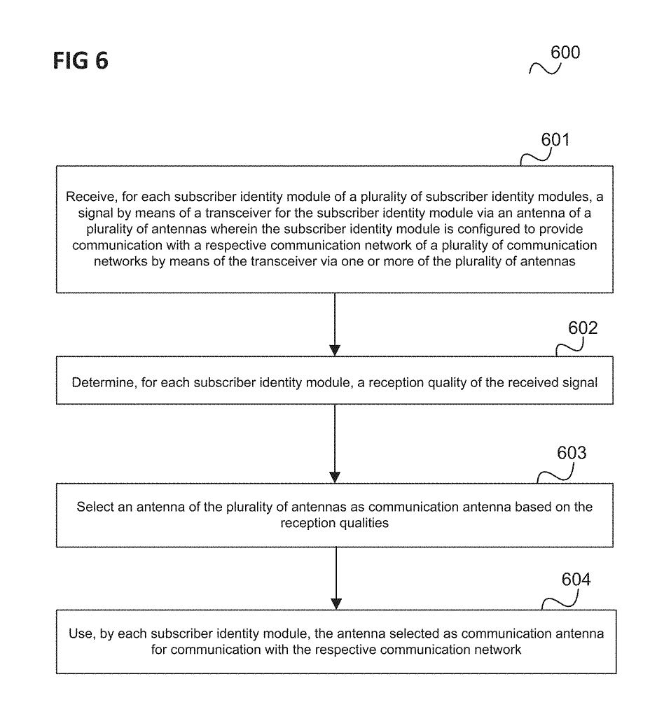

The communication terminal 500 for example carries out a method for selecting a communication antenna as illustrated in FIG. 6.

FIG. 6 shows a flow diagram 600.

The flow diagram 600 illustrates a method for selecting a communication antenna, for example carried out by a communication terminal.

In 601, the communication terminal receives, for each subscriber identity module of a plurality of subscriber identity modules, a signal by means of a transceiver for the subscriber identity module via an antenna of a plurality of antennas (wherein for one subscriber identity module, a signal may be received for each antenna of multiple antennas) wherein the subscriber identity module is configured to provide communication with a respective communication network of a plurality of communication networks by means of the transceiver via one or more of the plurality of antennas.

In 602, the communication terminal determines, for each subscriber identity module, a reception quality of the received signal (wherein, in case that multiple signals have been received for the same subscriber identity module via different antennas, a reception quality of each of the signals may be determined).

In 603, the communication terminal selects an antenna of the plurality of antennas as communication antenna based on the reception qualities.

In 604, each subscriber identity module uses the antenna selected as communication antenna for communication with the respective communication network.

The following examples pertain to further embodiments.

Example 1 is a communication terminal as illustrated in FIG. 5.

In Example 2, the subject matter of example 1 may optionally include a controller configured to control the subscriber identity modules to use the antenna selected as communication antenna for communication with the respective communication network.

In Example 3, the subject matter of example 2 may optionally include an arbiter configured to select one of the subscriber identity modules as the controller.

In Example 4, the subject matter of any one of examples 2-3 may optionally include the controller being configured to receive an indication of the antenna selected as communication antenna and being configured to control the subscriber identity modules to use the antenna selected as communication antenna for communication with the respective communication network based on the indication of the antenna selected as communication antenna.

In Example 5, the subject matter of any one of examples 1-4 may optionally include a storage and the determiner of each subscriber identity module being configured to transmit an indication of the determined reception quality to the storage.

In Example 6, the subject matter of example 5 may optionally include the antenna selector being configured to receive the indications of the reception qualities from the storage.

In Example 7, the subject matter of any one of examples 1-6 may optionally include the reception quality of a signal received by the transceiver being a reception power of the signal received by the transceiver.

In Example 8, the subject matter of any one of examples 1-7 may optionally include the signal being a reference signal or a pilot signal.

In Example 9, the subject matter of any one of examples 1-8 may optionally include the transceiver being configured to receive the signal received from a respective base station.

In Example 10, the subject matter of any one of examples 1-9 may optionally include, for each subscriber identity module, the determiner being configured to generate an indication of the reception quality it has determined and to provide the indication of the reception quality to the antenna selector.

In Example 11, the subject matter of any one of examples 1-10 may optionally include the antenna selector being configured to select the antenna as the communication antenna based on a predetermined communication antenna quality criterion.

In Example 12, the subject matter of any one of examples 1-11 may optionally include the antenna selector being configured to select the antenna with a best reception quality as the communication antenna based on the determined reception qualities.

In Example 13, the subject matter of any one of examples 1-12 may optionally include, for each subscriber identity module, the transceiver comprising one or more receive chains configured to provide samples of the received signal to the determiner.

In Example 14, the subject matter of any one of examples 1-13 may optionally include each subscriber identity module being configured to provide the communication to the respective communication network using a respective radio access technology.

In Example 15, the subject matter of any one of examples 1-14 may optionally include, for each subscriber identity module, the transceiver comprising a baseband processor and the determiner being implemented by the baseband processor.

Example 16 is a method for selecting a communication antenna as illustrated in FIG. 6.

In Example 17, the subject matter of example 16 may optionally include controlling the subscriber identity modules to use the antenna selected as communication antenna for communication with the respective communication network.

In Example 18, the subject matter of example 17 may optionally include selecting one of the subscriber identity modules for controlling the subscriber identity modules to use the antenna selected as communication antenna for communication with the respective communication network.

In Example 19, the subject matter of any one of examples 17-18 may optionally include receiving an indication of the antenna selected as communication antenna and controlling the subscriber identity modules to use the antenna selected as communication antenna for communication with the respective communication network based on the indication of the antenna selected as communication antenna.

In Example 20, the subject matter of any one of examples 16-19 may optionally include, for each subscriber identity module, transmitting an indication of the determined reception quality to the storage.

In Example 21, the subject matter of example 20 may optionally include receiving the indications of the reception qualities from the storage.

In Example 22, the subject matter of any one of examples 16-21 may optionally include the reception quality of a signal received being a reception power of the signal received.

In Example 23, the subject matter of any one of examples 16-22 may optionally include the signal being a reference signal or a pilot signal.

In Example 24, the subject matter of any one of examples 16-23 may optionally include receiving the signal from a respective base station.

In Example 25, the subject matter of any one of examples 16-24 may optionally include, for each subscriber identity module, generating an indication of the reception quality determined and providing the indication of the reception quality for selection of an antenna of the plurality of antennas as communication antenna.

In Example 26, the subject matter of any one of examples 16-25 may optionally include selecting the antenna as the communication antenna based on a predetermined communication antenna quality criterion.

In Example 27, the subject matter of any one of examples 16-26 may optionally include selecting the antenna with a best reception quality as the communication antenna based on the determined reception qualities.

In Example 28, the subject matter of any one of examples 16-27 may optionally include, for each subscriber identity module, one or more receive chains providing samples of the received signal.

In Example 29, the subject matter of any one of examples 16-28 may optionally include each subscriber identity module providing the communication to the respective communication network using a respective radio access technology.

In Example 30, the subject matter of any one of examples 16-29 may optionally include, for each subscriber identity module, a respective baseband processor determining the reception quality.

Example 31 is a computer readable medium having recorded instructions thereon which, when executed by a processor, make the processor perform a method for selecting a communication antenna according to any one of Examples 16-30.

It should be noted that one or more of the features of any of the examples above may be combined with any one of the other examples.

While specific aspects have been described, it should be understood by those skilled in the art that various changes in form and detail may be made therein without departing from the spirit and scope of the aspects of this disclosure as defined by the appended claims. The scope is thus indicated by the appended claims and all changes which come within the meaning and range of equivalency of the claims are therefore intended to be embraced.

What is claimed is:

1. A communication terminal comprising:
a plurality of antennas;
a plurality of subscriber identity modules;
a transceiver for each subscriber identity module, wherein the subscriber identity module is configured to provide communication with a respective communication network of a plurality of communication networks by means of the transceiver via one or more of the antennas;
a determiner for each subscriber identity module configured to determine, for at least one of the one or more of the antennas, a reception quality of a signal received by the transceiver for the subscriber identity module via the antenna;
an antenna selector configured to receive indications of the reception qualities and to select an antenna of the plurality of antennas as communication antenna;
wherein each subscriber identity module is configured to use the antenna selected as communication antenna for communication with the respective communication network.

2. The communication terminal of claim 1, comprising a controller configured to control the subscriber identity modules to use the antenna selected as communication antenna for communication with the respective communication network.

3. The communication terminal of claim 2, comprising an arbiter configured to select one of the subscriber identity modules as the controller.

4. The communication terminal of claim 2, wherein the controller is configured to receive an indication of the antenna selected as communication antenna and is configured to control the subscriber identity modules to use the antenna selected as communication antenna for communication with the respective communication network based on the indication of the antenna selected as communication antenna.

5. The communication terminal of claim 1, comprising a storage, wherein the determiner of each subscriber identity module is configured to transmit an indication of the determined reception quality to the storage.

6. The communication terminal of claim 5, wherein the antenna selector is configured to receive the indications of the reception qualities from the storage.

7. The communication terminal of claim 1, wherein the reception quality of a signal received by the transceiver is a reception power of the signal received by the transceiver.

8. The communication terminal of claim 1, wherein the signal is a reference signal or a pilot signal.

9. The communication terminal of claim 1, wherein the transceiver is configured to receive the signal received from a respective base station.

10. The communication terminal of claim 1, wherein, for each subscriber identity module, the determiner is configured to generate an indication of the reception quality it has determined and to provide the indication of the reception quality to the antenna selector.

11. The communication terminal of claim 1, wherein the antenna selector is configured to select the antenna as the communication antenna based on a predetermined communication antenna quality criterion.

12. The communication terminal of claim 1, wherein the antenna selector is configured to select the antenna with a best reception quality as the communication antenna based on the determined reception qualities.

13. The communication terminal of claim 1, wherein, for each subscriber identity module, the transceiver comprises one or more receive chains configured to provide samples of the received signal to the determiner.

14. The communication terminal of claim 1, wherein each subscriber identity module is configured to provide the communication to the respective communication network using a respective radio access technology.

15. The communication terminal of claim 1, wherein, for each subscriber identity module, the transceiver comprises a baseband processor and the determiner is implemented by the baseband processor.

16. Method for selecting a communication antenna comprising:
receiving, for each subscriber identity module of a plurality of subscriber identity modules, a signal by means of a transceiver for the subscriber identity module via an antenna of a plurality of antennas wherein the subscriber identity module is configured to provide communication with a respective communication network of a plurality of communication networks by means of the transceiver via one or more of the plurality of antennas;
determining, for each subscriber identity module, a reception quality of the received signal;
selecting an antenna of the plurality of antennas as communication antenna based on the reception qualities; and
each subscriber identity module using the antenna selected as communication antenna for communication with the respective communication network.

17. A computer readable medium having recorded instructions thereon which, when executed by a processor, make the processor perform a method for selecting a communication antenna according to claim 16.
